(19) United States
(12) Patent Application Publication
(10) Pub. No.: US 2025/0371697 A1
(43) Pub. Date: Dec. 4, 2025

(54) INK JET PRINTING APPARATUS AND DRAWING DATA GENERATION DEVICE

(71) Applicant: KEYENCE CORPORATION, Osaka (JP)

(72) Inventors: Mamoru Idaka, Osaka-shi (JP); Hidetake Sasaki, Osaka-shi (JP); Shota Nakano, Osaka-shi (JP)

(73) Assignee: KEYENCE CORPORATION, Osaka (JP)

(21) Appl. No.: 19/208,881

(22) Filed: May 15, 2025

(30) Foreign Application Priority Data
May 30, 2024 (JP) 2024-087827

(51) Int. Cl. G06T 7/00; B41J 3/28; B41J 3/46; B41J 11/00; G06K 15/00; G06K 15/02

(52) U.S. Cl. CPC G06T 7/0004; B41J 3/286; B41J 3/46; B41J 11/0095; G06K 15/007; G06K 15/1848; G06K 2215/101; G06T 2207/30144

(57) ABSTRACT

Drawing setting and inspection setting can be facilitated and the inspection can be easily stabilized, and thereby user convenience is enhanced. An ink jet printing apparatus includes: a drawing setting section that sets a drawing content to be drawn on an object to be drawn; a drawing data generation section that generates drawing data corresponding to the drawing content; an image inspection section that determines quality of a drawing state related to information drawn on the object; a storage section that stores information regarding inspection performance of the image inspection section; a determination section that determines whether an inspection by the image inspection section is stable based on the information regarding the inspection performance of the image inspection section stored in the storage section and the drawing content set by the drawing setting section; and a notification section that notifies a user of a determination result of the determination section.

### CROSS-REFERENCE TO RELATED APPLICATIONS

The present application claims foreign priority based on Japanese Patent Application No. 2024-087827, filed May 30, 2024, the contents of which are incorporated herein by reference.

### BACKGROUND OF THE INVENTION

### 1. Technical Field

The present disclosure relates to an ink jet printing apparatus and a drawing data generation device.

### 2. Description of the Related Art

For example, a drop on demand (DOD) type ink jet printing apparatus that performs printing by ejecting ink onto a packaging material such as cardboard is known (See, for example, JP2014-144574A.).

Furthermore, there is also known a technique of capturing an image of a pattern drawn by the DOD-type ink jet printing apparatus with a camera and executing various applications (highly accurate alignment and the like) using the obtained captured image (See, for example, JP2020-131141A).

However, for example, JP2020-131141A does not disclose a specific setting method for linking the ink jet printing apparatus and the camera. Generally, setting of a drawing content for the ink jet printing apparatus and inspection setting for the camera are executed. Therefore, when the inspection is not stable, it is necessary to adjust the setting of the drawing content and the inspection setting, and the user is forced to perform complicated work. Furthermore, there is a possibility that various settings become complicated, for example, the setting of the drawing content and the inspection setting need to be matched.

### SUMMARY OF THE INVENTION

The present disclosure has been made in view of such a point, and an object of the present disclosure is to facilitate setting of a drawing content and inspection setting, to easily stabilize an inspection, and thereby to enhance user convenience.

In order to achieve the above object, one embodiment of the present disclosure can be based on an ink jet printing apparatus that ejects ink for drawing information on an object and determines quality of a drawing state by imaging. The ink jet printing apparatus includes: for example, an ink accommodation section that accommodates the ink; an ejection section that ejects the ink supplied from the ink accommodation section toward an object to be drawn; a drawing setting section that sets a drawing content to be drawn on the object to be drawn; a drawing data generation section that defines ejection of the ink in the ejection section and generates drawing data corresponding to the drawing content set by the drawing setting section; an image inspection section that determines quality of a drawing state related to information drawn on the object to be drawn based on the drawing data by a captured image acquired by capturing an image of the object to be drawn; a storage section that stores information regarding inspection performance of the image inspection section; a determination section that determines whether or not an inspection by the image inspection section is stable based on the information regarding the inspection performance of the image inspection section stored in the storage section and the drawing content set by the drawing setting section; and a notification section that notifies a user of a determination result of the determination section.

According to this configuration, since the user can acquire the determination result as to whether or not the inspection by the image inspection section is stable when the drawing content is set, the user only needs to set the drawing content so that the inspection by the image inspection section is stable, and it is not necessary to adjust the setting of the drawing content and the inspection setting, and it is also not necessary to match the setting of the drawing content and the inspection setting.

Furthermore, another embodiment of the present disclosure may be based on a drawing data generation device for an ink jet printing apparatus. The drawing data generation device includes: a drawing setting section that sets a drawing content; a drawing data generation section that defines ejection of ink in an ejection section of the ink jet printing apparatus and generates drawing data corresponding to the drawing content set by the drawing setting section; a storage section that stores information regarding inspection performance of an image inspection device that determines quality of a drawing state related to information drawn on an object to be drawn based on the drawing data by a captured image acquired by capturing an image of the object to be drawn; a determination section that determines whether or not an inspection by the image inspection device is stable based on the information regarding the inspection performance of the image inspection device stored in the storage section and the drawing content set by the drawing setting section; and a notification section that notifies a user of a determination result of the determination section.

As described above, according to the ink jet printing apparatus and the drawing data generation device of the present disclosure, the setting of the drawing content and the inspection setting can be facilitated, the image inspection can be easily stabilized, and thereby the user convenience can be enhanced.

### BRIEF DESCRIPTION OF THE DRAWINGS

FIG. 1 is a diagram illustrating an overall configuration of an ink jet printing apparatus according to an embodiment of the present invention;

FIG. 2 is a block diagram of the ink jet printing apparatus;

FIG. 3 is a flowchart illustrating a flow of processing at the time of setting;

FIG. 4 is a diagram illustrating an example of a drawing setting screen;

FIG. 5 is a diagram illustrating an example of a job list display screen;

FIG. 6 is a diagram illustrating an example of a drawing element list display screen;

FIG. 7 is a diagram illustrating an example of a block addition screen;

FIG. 8 is a diagram illustrating an example of a block editing screen;

FIG. 9 is a diagram illustrating an example of an input window of a height of a character and an interval between characters;

FIG. 10 is a diagram illustrating an example of a screen notifying that an inspection may not be stable;

FIG. 11 is a diagram illustrating an example of a message window displaying a determination reason;

FIG. 12 is a diagram illustrating a frame line for securing a predetermined distance or more between a character string and another drawing element;

FIG. 13 is a diagram illustrating an example of a drawing density editing screen;

FIG. 14 is a diagram illustrating an example of a message window displayed before saving; and

FIG. 15 is a diagram illustrating an example of a system configuration screen.

### DETAILED DESCRIPTION

Hereinafter, embodiments of the present invention will be described in detail with reference to the drawings. It is to be noted that the following description of preferred embodiments is merely exemplary in nature and is not intended to limit the present invention, its application, or its use.

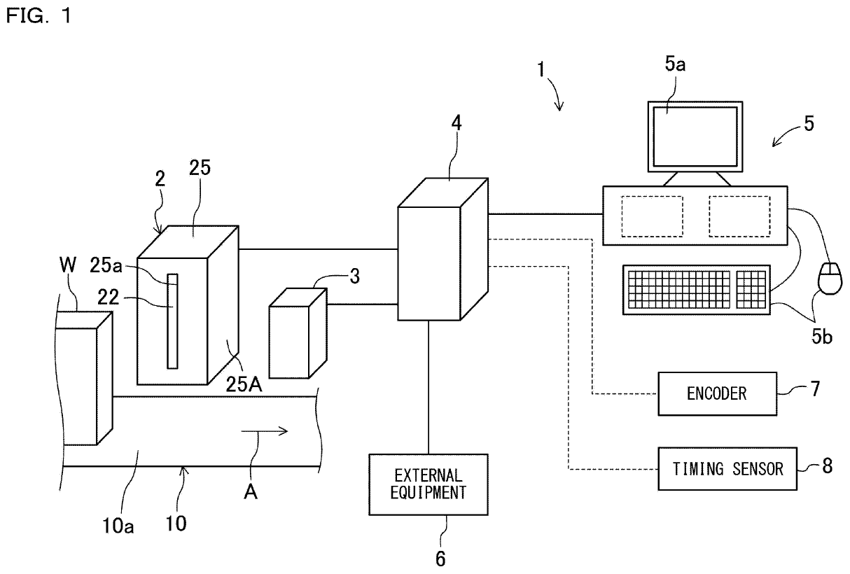

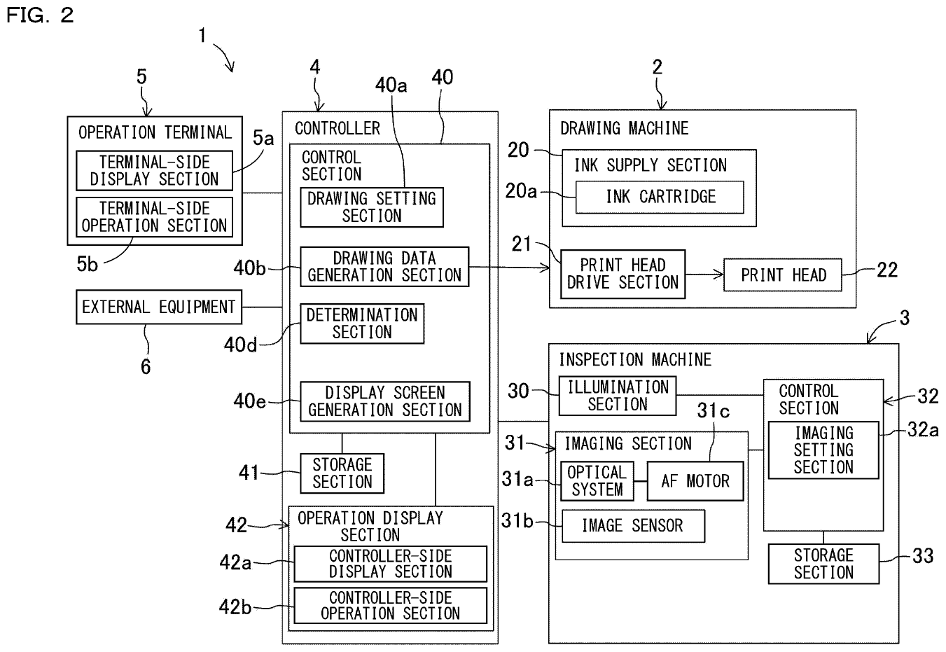

FIG. 1 is a diagram illustrating an overall configuration at the time of operation of an ink jet printing apparatus 1 according to an embodiment of the present invention, and FIG. 2 is a block diagram of the ink jet printing apparatus 1. The ink jet printing apparatus 1 includes, for example, a drawing machine 2, an inspection machine 3, a controller 4, and an operation terminal 5.

The drawing machine 2 is a part that performs a drawing process on an object to be drawn, and is configured separately from the controller 4. The inspection machine 3 is a part that determines the quality of the drawing state executed on the object to be drawn by the drawing machine 2, and is configured separately from the controller 4. Since the ink jet printing apparatus 1 according to the present embodiment includes the drawing machine 2 and the inspection machine 3, the ink jet printing apparatus 1 is an ink jet printing apparatus that ejects ink for drawing information on an object and determines the quality of a drawing state by imaging.

The controller 4 is a part that controls the drawing machine 2 and the inspection machine 3, and can also be referred to as a control device, a control unit, or the like. Furthermore, the operation terminal 5 includes a personal computer or the like, and is a portion where a user inputs drawing information, performs various settings, selects, confirms, and the like, for example. The operation terminal 5 includes a terminal-side display section 5a including, for example, a liquid crystal display and a terminal-side operation section 5b including a keyboard, a mouse, a pointing device, and the like.

The above configuration example is an example, and the present invention is not limited to the above configuration example. That is, the controller 4 may be incorporated in the operation terminal 5 or may be incorporated in the drawing machine 2. Furthermore, the operation terminal 5 may function as the controller 4. Furthermore, FIGS. 1 and 2 illustrate external equipment 6 including a programmable logic controller (PLC) or the like, and the external equipment 6 is communicably connected to the controller 4. Moreover, a control signal output from the external equipment 6 is input to the controller 4. The external equipment 6 may be equipment constituting a part of the ink jet printing apparatus 1, or may be equipment different from the ink jet printing apparatus 1.

The ink jet printing apparatus 1 is a device for drawing various types of information on a workpiece W (an example of a drawing target object) conveyed by a conveyor 10, and is an in-line device used by being incorporated in a manufacturing line (also referred to as a production line). The conveyor 10 is, for example, a belt conveyor, a roller conveyor, or the like. The production line is configured by the conveyor 10. The production line is installed in various factories, warehouses, and the like. The drawing machine 2 is fixed such that the relative position with respect to the conveyor 10 has a predetermined positional relationship.

During operation of the ink jet printing apparatus 1, the plurality of workpieces W are sequentially conveyed in the direction of the arrow A illustrated in FIG. 1 in a state of being placed on a conveying surface 10a of the conveyor 10. Therefore, the upstream side in the conveyance direction is the left side in FIG. 1, and the downstream side in the conveyance direction is the right side in FIG. 1. The plurality of workpieces W are placed on the conveyance surface 10a in a state of being spaced apart from each other in the direction of the arrow A which is the conveyance direction. A direction orthogonal to the direction of the arrow A and along the conveyance surface 10a is defined as a width direction.

The workpiece W is not particularly limited, and examples thereof include a packing material for packing various products. As a typical example of the packing material, for example, cardboard and the like can be mentioned. The ink jet printing apparatus 1 draws information such as characters including numbers, symbols, bar codes, two-dimensional codes, images, marks, illustrations, combinations thereof, and the like on the workpiece W conveyed by the conveyor 10. In a case where only characters are drawn, the ink jet printing apparatus 1 can also be referred to as a printing apparatus or the like, and the drawing machine 2 can also be referred to as a printing machine. Furthermore, the drawing of information by the ink jet printing apparatus 1 also includes the case of printing an image or the like. In this case, the ink jet printing apparatus 1 can be referred to as a printing apparatus. In the following description, printing and print are simply referred to as drawing.

Furthermore, an encoder 7, a timing sensor 8, and the like for detecting the position of the workpiece W are connected to the controller 4. The controller 4 detects the position of the workpiece W based on signals output from the encoder 7 and the timing sensor 8. The controller 4 controls the drawing machine 2 so that drawing is started when the workpiece W reaches a predetermined position.

### (Configuration of Drawing Machine 2)

The drawing machine 2 is a drop on demand (DOD) type drawing machine that ejects ink only when necessary as a drawing operation, but may be a continuous ink jet (CIJ) type drawing machine that ejects ink even when the drawing operation is not performed, in addition to the DOD type drawing machine. Hereinafter, a case where a drawing machine of the DOD system is used as the drawing machine 2 of the present embodiment will be described.

As illustrated in FIG. 2, the drawing machine 2 includes an ink supply section 20, a print head drive section 21, and a DOD print head (Hereinafter, referred to as a print head.) 22. The drawing machine 2 also includes a main housing 25 (illustrated in FIG. 1) in which the print head 22 is provided. The main housing 25 is fixed to the conveyor 10 or the like.

The print head 22 is fixed in a state of being accommodated in the main housing 25, and a positional relationship between the main housing 25 and the print head 22 is fixed. Furthermore, the ink supply section 20 and the print head drive section 21 are also accommodated inside the main housing 25.

The print head 22 of the DOD type drawing machine 2 is a member corresponding to an ejection section, and ejects ink for drawing information on the workpiece W. There are a plurality of types of structures of the print head 22, and for example, any of a thermal ink jet type, a valve jet type, and a piezo type may be used. In the present embodiment, a piezoelectric print head capable of performing low resolution to high resolution drawing, having a wide drawing width, and having high durability is used as the print head 22.

In the print head 22, a plurality of ejection ports (not illustrated) are formed, for example, along the vertical direction. As illustrated in FIG. 1, an opening 25a that is long in the vertical direction is formed on a surface of the main housing 25 facing the workpiece W. The surface of the print head 22 on which the ejection port is formed is disposed so as to face the outside from the opening 25a of the main housing 25. Therefore, the ink ejected from the ejection port of the print head 22 jumps out of the main housing 25 from the opening 25a of the main housing 25 and adheres to the workpiece W.

The ink supply section 20 is a portion that supplies ink to the print head 22, and includes an ink cartridge 20a as an ink accommodation section that accommodates ink. Instead of the ink cartridge 20a, an ink reservoir (ink accommodation section) that can refill ink may be provided.

The print head drive section 21 is controlled by a control section 40 described later when performing the drawing operation. The print head drive section 21 generates a driving electric waveform for driving the print head 22 and outputs the driving electric waveform to the print head 22. The drive electric waveform is a waveform for individually driving the drive element (piezoelectric vibrator) provided for each ejection orifice of the print head 22 at a timing based on the drawing command output from the control section 40. The print head 22 discharges the ink supplied from the ink cartridge 20a toward the workpiece W to be drawn to draw on the workpiece W to be drawn. Note that the control of the ejection timing may be performed by the print head 22 itself instead of the control section 40.

### (Configuration of Inspection Machine)

The inspection machine 3 is a device that determines the quality of the drawing state related to the information drawn on the workpiece W to be drawn based on the drawing data by a captured image acquired by capturing an image of the workpiece W to be drawn, and corresponds to an image inspection section. Furthermore, the inspection machine 3 can also be referred to as an image inspection device. The inspection machine 3 is installed downstream of the drawing machine 2, and can inspect the drawing state of the workpiece W drawn by the drawing machine 2.

The inspection machine 3 includes an illumination section 30, an imaging section 31, a control section 32, and a storage section 33. The illumination section 30 includes, for example, a light emitting diode or the like, and is controlled by the control section 32 to emit light at a predetermined timing to illuminate a drawn portion of the workpiece W. The imaging section 31 includes an optical system 31a including a lens that receives light emitted from the illumination section 30 and reflected from the surface of the workpiece W, an image sensor 31b that receives light emitted from the optical system 31a, and an AF motor 31c. The AF motor 31c is a member for automatically focusing on the drawing portion of the workpiece W by driving the focusing lens of the optical system 31a. The autofocus method is not particularly limited, and examples thereof include a contrast method.

The image sensor 31b includes, for example, a complementary metal oxide semiconductor (CMOS) sensor or the like. The image sensor 31b images the workpiece W to be drawn and generates a captured image. For example, although not illustrated, the light reception amount signal of the light receiving element of the image sensor 31b is output to a field programmable gate array (FPGA) and processed, and is also output to a digital signal processor (DSP) and processed.

The control section 32 includes an imaging setting section 32a. The imaging setting section 32a is a portion that sets the imaging setting parameters and reflects the set imaging setting parameters at the time of imaging the workpiece W. The imaging setting parameters include, for example, a plurality of parameters such as timing of illumination by the illumination section 30, brightness (light emission amount), exposure time by the imaging section 31, and focus (focal position) of the imaging section 31. Although not illustrated, the GUI related to the setting of the imaging setting parameters is provided with an area in which brightness of illumination, exposure time, focus, and the like can be individually set. When the user inputs each parameter on the GUI, the imaging setting section 32a accepts a setting operation by the user, outputs each parameter to, for example, the storage section 33, and causes the storage section 33 to store the parameter. Each parameter can be read from the storage section 33 as necessary.

When acquiring the captured image data of the workpiece W, the imaging setting section 32a outputs the imaging setting parameters to the illumination section 30 and the imaging section 31. The illumination section 30 and the imaging section 31 operate according to the imaging setting parameters. Upon receiving the imaging setting parameter, the illumination section 30 sets the received imaging setting parameter in the imaging section 31 so as to reflect the received imaging setting parameter at the time of imaging. Furthermore, when receiving the imaging setting parameter, the imaging section 31 also sets the received imaging setting parameter in the imaging section 31 so as to reflect the received imaging setting parameter at the time of imaging. Upon receiving the imaging trigger, the illumination section 30 and the imaging section 31 illuminate the workpiece W in accordance with the imaging setting parameters and acquire captured image data of the workpiece W by imaging.

The control section 32 may be a part that executes the rule-based image inspection, a part that executes the image inspection using the pre-learned model, or a part that executes both the rule-based image inspection and the image inspection using the pre-learned model as the inspection tool. For example, the control section 32 causes the imaging section 31 to image the workpiece W, acquires captured image data of the workpiece W, and executes an inspection based on a set inspection tool on the acquired captured image of the workpiece W. When executing the inspection, the control section 32 cuts out a range to be inspected from the captured image. The control section 32 extracts a characteristic amount of the cut inspection range, and determines the extracted characteristic amount by a determination device. In a case where characters are included in the cut out inspection range, the inspection machine 3 can perform character recognition processing, so-called OCR, by using the dictionary when performing character recognition. Furthermore, in a case where a bar code or a two-dimensional code is drawn on the workpiece W, the bar code or the two-dimensional code can be read by the inspection machine 3.

After the determination by the inspection machine 3, the control section 32 creates an inspection result by the inspection tool and compares the inspection result with the inspection condition at this time. The inspection condition is acquired from a drawing data generation section 40b of the controller 4. For example, the result of the character recognition processing by the control section 32 is compared with the correct character string acquired from the drawing data generation section 40b, and it is determined as good in a case where they coincide with each other, and it is determined as poor in a case where they do not coincide with each other. In the case of a barcode or a two-dimensional code, the reading result of the control section 32 is compared with the code information acquired from the drawing data generation section 40b, and in a case where the reading result matches the code information, it is determined as good, and in a case where the reading result does not match the code information, it is determined as poor.

For example, in a case where there is one set inspection tool, the inspection result related to the set inspection tool is output as it is, but in a case where a plurality of set inspection tools is combined, the inspection result is further generated and output on the basis of the inspection result of each inspection tool.

### (Configuration of Controller 4)

As illustrated in FIG. 2, the controller 4 includes the control section 40, a storage section 41, and an operation display section 42. The control section 40 includes, for example, a microcomputer including a central processing device, various memories, and the like, and can execute software stored in advance. The control section 40 is provided with a drawing setting section 40a, the drawing data generation section 40b, a determination section 40d, and a display screen generation section 40e. The drawing setting section 40a, the drawing data generation section 40b, the determination section 40d, and the display screen generation section 40e of the control section 40 are parts configured by hardware and software, and are described separately as the drawing setting section 40a, the drawing data generation section 40b, the determination section 40d, and the display screen generation section 40e for convenience, but may be integrated in hardware.

The operation display section 42 includes a controller-side display section 42a including, for example, a liquid crystal display and a controller-side operation section 42b including operation keys and the like. The controller-side operation section 42b receives various operations such as drawing contents and settings. Various screens generated by the display screen generation section 40e are displayed on the controller-side display section 42a, and the user can operate the controller-side operation section 42b while viewing the controller-side display section 42a. The operation state of the controller-side operation section 42b can be acquired by the control section 40.

The controller-side operation section 42b may be a touch panel. The touch panel is a member capable of detecting an operation by a user's finger. The type of the touch panel is not particularly limited, and examples thereof include a capacitance type and an infrared type. Operation information of the touch panel by the user is transmitted to the control section 40.

The drawing setting section 40a is a section that sets a drawing content to be drawn on the workpiece W to be drawn. The drawing data generation section 40b is a section that defines ejection of ink in the print head 22 and generates drawing data corresponding to the drawing content set by the drawing setting section 40a. The control section 40 outputs a control signal to the print head drive section 21 based on the drawing data generated by the drawing data generation section 40b, and controls ejection of ink from the ejection orifice of the print head 22.

The storage section 41 stores information regarding the inspection performance of the inspection machine 3. Examples of the information regarding the inspection performance of the inspection machine 3 include a type of font, a character size (also referred to as a character height), a character interval, a character type, the number of characters, a density of drawing, a bar size, a cell size, a distance from another drawing element, and the like. The type of font, the character size, the character interval, the character type, and the number of characters are examples of information regarding inspection performance in a case where the drawing element is a character. The bar size is an example of information regarding inspection performance in a case where the drawing element is a barcode. The cell size is an example of information regarding inspection performance in a case where the drawing element is a two-dimensional code. Whether the drawing element is a character, a barcode, or a two-dimensional code, the density of drawing and the distance from another drawing element can be information regarding inspection performance. The type of the font and the character type are “type”, the character size, the character interval, the number of characters, and the density of drawing are “numerical value”, and the interval with other drawing elements is “position”. As described above, the information regarding the inspection performance of the inspection machine 3 includes the information classified as the “type”, the information classified as the “numerical value”, and the information classified as the “position”. The information regarding the inspection performance of the inspection machine 3 stored in the storage section 41 is determined in advance according to the inspection performance of the inspection machine 3.

The information regarding the inspection performance of the inspection machine 3 will be described more specifically. In a case where the drawing element is a character, depending on the type of font, the inspection machine 3 may easily read the character or may have difficulty in reading the character. Therefore, the type of font having high inspection performance (easy to read) by the inspection machine 3 is stored as information regarding the inspection performance of the inspection machine 3. Furthermore, the type of font having low inspection performance (difficult to read) by the inspection machine 3 may be stored as the information regarding the inspection performance of the inspection machine 3. In other words, the type of font (information regarding the inspection performance of the inspection machine 3) stored in the storage section 41 is determined depending on the inspection performance of the inspection machine 3. As described above, the inspection machine 3 uses the dictionary for character recognition. By narrowing down the target of the dictionary, erroneous reading by the inspection machine 3 is reduced. Furthermore, the font having high inspection performance may be limited to the equal width font, and by limiting to the equal width font, cutout of characters is stabilized, and dictionary performance is also stabilized.

In a case where the drawing element is a character, depending on the character size, the inspection machine 3 may easily read the character or may have difficulty in reading the character. This is because the inspection machine 3 performs image inspection, and thus, there is a limit in image resolution. Therefore, the lower limit of the character size with high inspection performance (easy to read) by the inspection machine 3 is stored as the information regarding the inspection performance of the inspection machine 3. Furthermore, a character size with low inspection performance (difficult to read) by the inspection machine 3 may be stored as information regarding the inspection performance of the inspection machine 3. In other words, the character size (information regarding the inspection performance of the inspection machine 3) stored in the storage section 41 is determined depending on the inspection performance of the inspection machine 3. The section of the character size is not particularly limited, and examples thereof include mm and inches.

In a case where the drawing element is a character, depending on the character interval, the inspection machine 3 may easily read the character or may have difficulty in reading the character. When the character interval is wide, the clipping of characters from the captured image is stable, but when the character interval is narrow, the clipping of characters from the captured image becomes unstable. Therefore, the lower limit of the character interval with high inspection performance (easy to read) by the inspection machine 3 is stored as information regarding the inspection performance of the inspection machine 3. Furthermore, a character interval with low inspection performance (difficult to read) by the inspection machine 3 may be stored as information regarding the inspection performance of the inspection machine 3. In other words, the character interval (information regarding the inspection performance of the inspection machine 3) stored in the storage section 41 is determined depending on the inspection performance of the inspection machine 3. The section of the character interval is not particularly limited, and examples thereof include mm and inches.

In a case where the drawing element is a character, depending on the character type, the inspection machine 3 may easily read the character or may have difficulty in reading the character. Therefore, a character type having high inspection performance (easy to read) by the inspection machine 3 is stored as information regarding the inspection performance of the inspection machine 3. Furthermore, a character type with low inspection performance (difficult to read) by the inspection machine 3 may be stored as information regarding the inspection performance of the inspection machine 3. In other words, the character type (information regarding the inspection performance of the inspection machine 3) stored in the storage section 41 is determined depending on the inspection performance of the inspection machine 3. Specifically, uppercase and lowercase letters of the alphabet are the character type, and lowercase letters that are difficult to distinguish from uppercase letters can be the character type with low inspection performance.

In a case where the drawing element is a character, depending on the number of characters, the inspection machine 3 may easily read the character or may have difficulty in reading the character. For example, by limiting the number of inspectable characters from the angle of view of the imaging section 31, deterioration in inspection performance can be suppressed. The upper limit of the number of characters having high inspection performance (easy to read) by the inspection machine 3 is stored as information regarding the inspection performance of the inspection machine 3. Furthermore, the number of characters having low inspection performance (difficult to read) by the inspection machine 3 may be stored as information regarding the inspection performance of the inspection machine 3. In other words, the number of characters (information regarding the inspection performance of the inspection machine 3) stored in the storage section 41 is determined depending on the inspection performance of the inspection machine 3.

Depending on the density of the drawing, the inspection machine 3 may easily determine the drawing state or may be difficult to determine the drawing state. This is because the higher the contrast, the more stable the determination result is. The density of drawing with high inspection performance (easy to read) by the inspection machine 3 is stored as information regarding the inspection performance of the inspection machine 3. Furthermore, the density of drawing with low inspection performance (difficult to read) by the inspection machine 3 may be stored as information regarding the inspection performance of the inspection machine 3. In other words, depending on the inspection performance of the inspection machine 3, the density of the drawing (information regarding the inspection performance of the inspection machine 3) stored in the storage section 41 is determined.

In a case where the drawing element is a character, the inspection machine 3 may easily read the character or may have difficulty in reading the character depending on the distance from other drawing elements. For example, if the distance between the character and another drawing element is narrow, the character cutout becomes unstable, but if the distance is wide, the character cutout becomes stable. As the interval between the characters and the other drawing elements, an interval with high inspection performance (easy to read) by the inspection machine 3 is stored as information regarding the inspection performance of the inspection machine 3. Furthermore, an interval at which the inspection performance of the inspection machine 3 is low (difficult to read) may be stored as information regarding the inspection performance of the inspection machine 3. In other words, an interval between a character stored in the storage section 41 and another drawing element (information regarding the inspection performance of the inspection machine 3) is determined depending on the inspection performance of the inspection machine 3.

In a case where the drawing element is a bar code or a two-dimensional code, the bar size and the cell size are stored as information regarding the inspection performance of the inspection machine 3. This is because the inspection machine 3 performs image inspection, and thus, there is a limit in image resolution. The lower limit of the bar size and the lower limit of the cell size with high inspection performance (easy to read) by the inspection machine 3 are stored as information regarding the inspection performance of the inspection machine 3. Furthermore, a bar size and a cell size having low inspection performance (difficult to read) by the inspection machine 3 may be stored as information regarding the inspection performance of the inspection machine 3. In other words, the bar size and the cell size (information regarding the inspection performance of the inspection machine 3) stored in the storage section 41 are determined depending on the inspection performance of the inspection machine 3.

Even in a case where the drawing element is a barcode or a two-dimensional code, the inspection machine 3 may easily read the barcode or the two-dimensional code or may have difficulty in reading the barcode or the two-dimensional code depending on a distance from another drawing element. For example, when the interval between the barcode or the two-dimensional code and another drawing element is narrow, the cutting out of the code area becomes unstable, but if the interval is wide, the cutting out of the code area becomes stable. As the interval between the barcode or the two-dimensional code and another drawing element, an interval with high inspection performance (easy to read) by the inspection machine 3 is stored as information regarding the inspection performance of the inspection machine 3. Furthermore, an interval at which the inspection performance of the inspection machine 3 is low (difficult to read) may be stored as information regarding the inspection performance of the inspection machine 3. In other words, the distance between the barcode and the two-dimensional code stored in the storage section 41 and the other drawing elements (information regarding the inspection performance of the inspection machine 3) is determined depending on the inspection performance of the inspection machine 3.

In a case where it is assumed that the drawing machine 2 performs drawing under the above constraint, the inspection performance of the inspection machine 3 is stabilized by designing the inspection machine 3 assuming that the drawing machine 2 performs drawing under the above constraint.

The determination section 40d reads the information regarding the inspection performance of the inspection machine 3 stored in the storage section 41, and reads the drawing content set by the drawing setting section 40a. The determination section 40d is a section that determines whether or not the inspection by the inspection machine 3 is stable based on the information regarding the inspection performance of the inspection machine 3 stored in the storage section 41 and the drawing content set by the drawing setting section 40a. In a case where the above limit is not exceeded, it is determined that the inspection by the inspection machine 3 is stable, and in a case where the above limit is exceeded, it is determined that there is a possibility that the inspection by the inspection machine 3 becomes unstable. In a case where it is determined that there is a possibility that the inspection by the inspection machine 3 becomes unstable, it is possible to select either setting is not possible at all as an error or setting is possible while warning that there is a possibility that the inspection becomes unstable.

The determination section 40d acquires a distance (working distance) between the imaging section 31 and the workpiece W to be drawn. The distance between the imaging section 31 and the workpiece W to be drawn may be measured and input by the user, may be set in advance, or may be estimated from the driving amount of the lens by the AF motor 31c. Then, the determination section 40d can also determine whether or not the inspection by the inspection machine 3 is stable based on the information regarding the inspection performance of the inspection machine 3 and the distance between the imaging section 31 and the workpiece W to be drawn.

The determination result of the determination section 40d is notified to the user. Examples of the form of the notification to the user include a form in which the determination result of the determination section 40d is displayed on the controller-side display section 42a, a form in which the determination result of the determination section 40d is displayed on the terminal-side display section 5a, and the like, but any form may be used. The controller-side display section 42a and the terminal-side display section 5a are members that can serve as the notification section of the present invention.

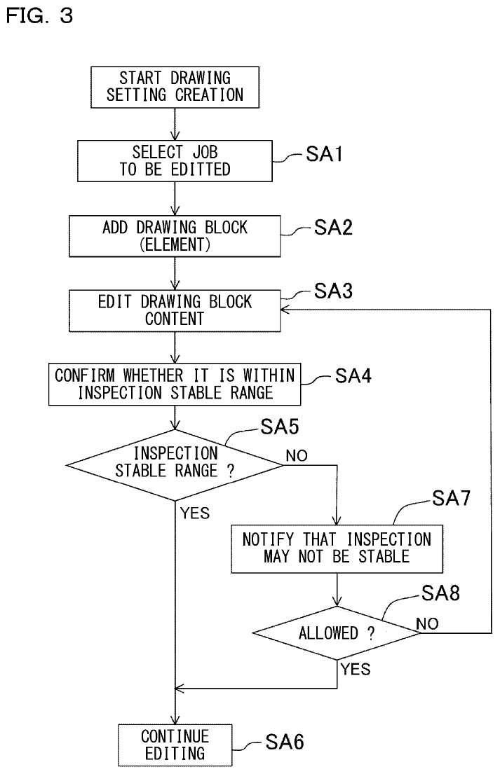

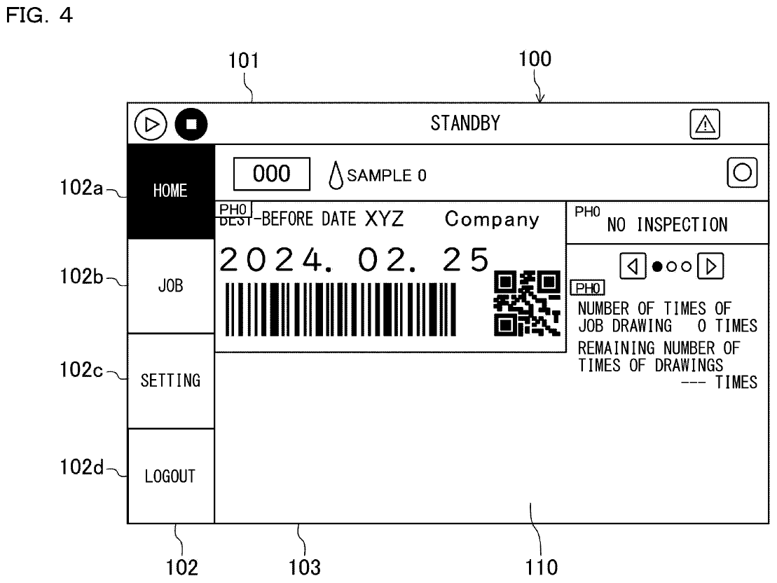

Hereinafter, the present embodiment will be described in detail based on a flowchart illustrated in FIG. 3. This flowchart starts when creation of drawing settings by the user is started. At the start, the display screen generation section 40e generates screen data for displaying a setting screen 100 as illustrated in FIG. 4 and outputs the screen data to the controller 4, and the setting screen 100 is displayed on the controller-side display section 42a.

On the upper part of the setting screen 100, a status display area 101 for displaying the status of the ink jet printing apparatus 1 is provided. A screen switching area 102 is provided on the left side of the setting screen 100. The screen switching area 102 is provided with a home button 102a for displaying a home screen, a job button 102b for displaying a job editing screen, a setting button 102c for displaying a setting screen for performing various settings, and a logout button 102d for ending drawing settings. The buttons 102a to 102d can be operated by the controller-side operation section 42b. Hereinafter, all operations on the screen can be operated by the controller-side operation section 42b.

FIG. 4 illustrates a state in which the home button 102a is pressed, and thus, the home screen 110 is displayed in an area 103 on the right side of the screen switching area 102 on the setting screen 100.

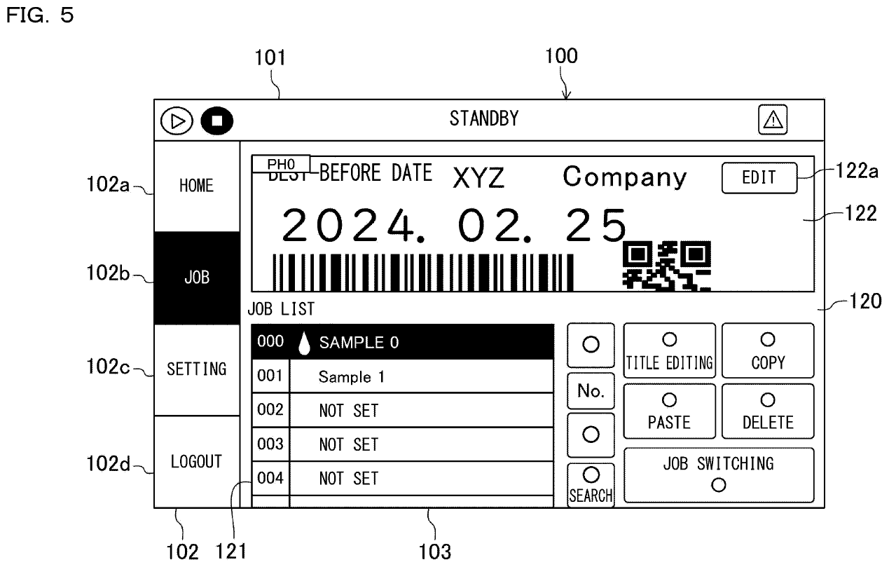

When the user operates the controller-side operation section 42b to press the job button 102b on the setting screen 100, the process proceeds to step SA1 of the flowchart illustrated in FIG. 3. When the process proceeds to step SA1, as illustrated in FIG. 5, the display screen generation section 40e generates screen data for displaying a job editing screen 120 in the area 103 of the setting screen 100 and displays the screen data on the controller-side display section 42a.

In step SA1, the drawing setting section 40a receives selection of a job to be edited from the user. That is, a job display area 121 in which a list of jobs is displayed is provided in a lower portion of the job editing screen 120. In the state illustrated in FIG. 5, a case where the uppermost job “000 SAMPLE 0” in the job display area 121 is selected is illustrated. A drawing content display area 122 is provided in an upper portion of the job editing screen 120. The drawing content display area 122 displays the drawing content of the job selected in the job display area 121. The drawing content display area 122 is provided with an edit button 122a.

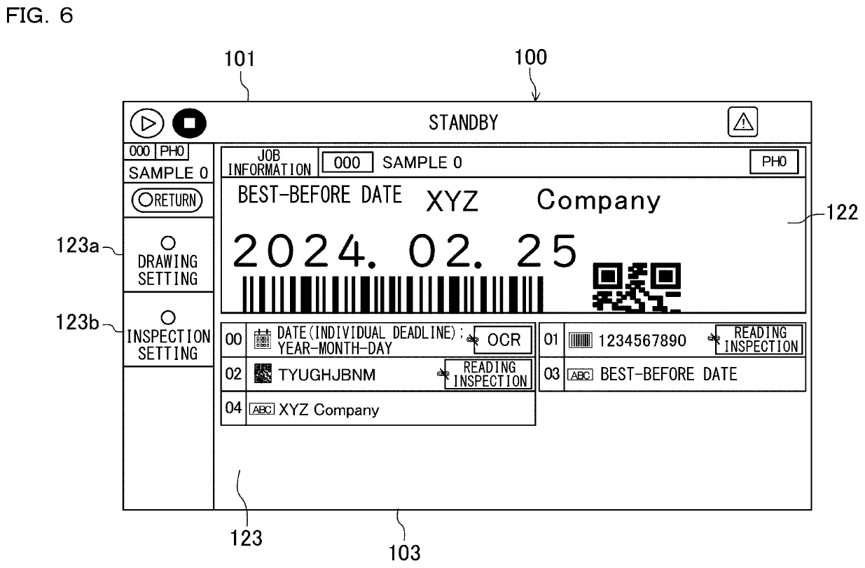

When the display screen generation section 40e detects that the edit button 122a is operated by the user, the drawing element display area 123 is displayed in the lower portion of the drawing content display area 122 as illustrated in FIG. 6. In the drawing element display area 123, a list of drawing elements is displayed. In the example illustrated in FIG. 6, since there are a date of “00”, a barcode of “01”, a two-dimensional code of “02”, a character string “best-before date” of “03”, and a character string “XYZ Company” of “04” as the drawing elements, five drawing elements are displayed in the drawing element display area 123.

In a case where the drawing element is a character string, since the character recognition, the number of characters (the number of clusters), and the presence or absence (area) of drawing are general inspection contents in the inspection by the inspection machine 3, the inspection contents (OCR) are displayed in the drawing element display area 123 as candidates. Furthermore, in a case where the drawing element is a barcode, since decoding (reading inspection) of the barcode, a grade of the barcode, and presence or absence (area) of drawing are general inspection contents in the inspection by the inspection machine 3, the inspection contents are displayed in the drawing element display area 123 as candidates. Furthermore, in a case where the drawing element is a two-dimensional code, decoding (reading inspection) of the two-dimensional code, a grade of the two-dimensional code, and presence or absence (area) of drawing are common inspection contents in the inspection by the inspection machine 3, and thus, the inspection contents are displayed in the drawing element display area 123 as candidates. Moreover, in a case where the drawing element is an image such as a logo, the number of edges of the image and the presence or absence (area) of drawing are common inspection contents in the inspection by the inspection machine 3, and thus, the inspection contents are displayed in the drawing element display area 123 as candidates. As described above, since the drawing machine 2 and the inspection machine 3 are integrated into the ink jet printing apparatus 1, the candidates for the inspection content suitable for the drawing element can be indicated based on the type of the drawing element. As a result, the user can easily and reliably select an appropriate inspection setting.

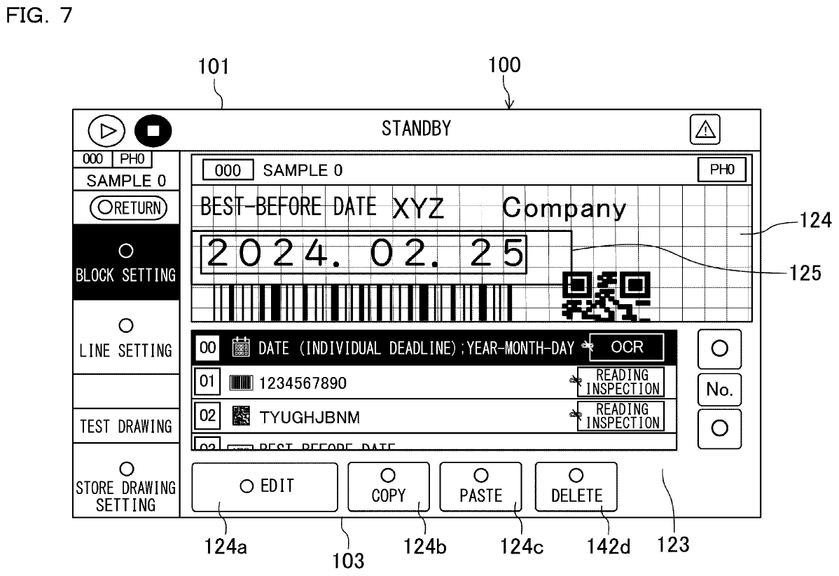

As illustrated in FIG. 6, a drawing setting button 123a and an inspection setting button 123b are provided on the left side of the drawing content display area 122. When the drawing setting button 123a is operated, an additional screen 124 to which a block (also referred to as a drawing block) can be added is displayed as illustrated in FIG. 7. The block indicates an area for arranging the drawing element, and can be added at an arbitrary position in the additional screen 124. This step is a step of adding a drawing block in step SA2.

A drawing element is displayed in the block. The drawing element display area 123 is provided below the addition screen 124, and an edit button 124a, a copy button 124b, a paste button 124c, and a delete button 124d for the added block are provided below the drawing element display area 123. The added block is illustrated surrounded by a frame line 125 (see FIG. 7). The frame line 125 will be described later. The added block can be copied by the copy button 124b and pasted by the paste button 124c. Furthermore, the added block can also be deleted by the delete button 124d.

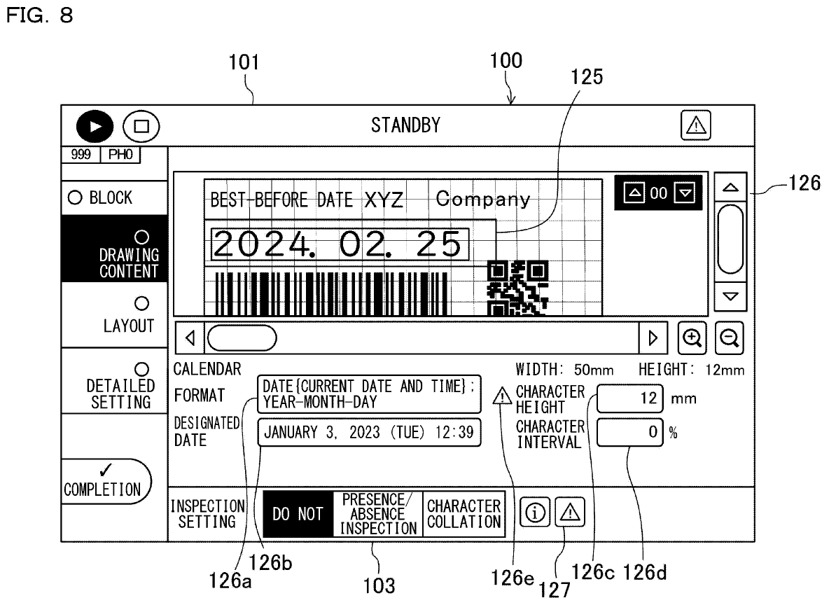

When the edit button 124a is operated in a state where the added block exists, the process proceeds to step SA3 of the flowchart illustrated in FIG. 3. When the process proceeds to step SA3, as illustrated in FIG. 8, the display screen generation section 40e generates screen data for displaying a block editing screen 126 in the area 103 of the setting screen 100 and displays the screen data on the controller-side display section 42a. For example, in a case where the block is a calendar, the block editing screen 126 is provided with a format setting area 126a, a setting area 126b for a designated date, a character height (character size) setting area 126c, a character interval setting area 126d, and the like. For example, in the character height setting area 126c, the height of the character inside the frame line 125 can be set to “mm” or “inch”, and accordingly, the drawing setting section 40a can receive the setting of the character size by the user. Furthermore, in the character interval setting area 126d, the character interval can be set to “%”, and as described above, the character interval is included in the drawing contents set by the drawing setting section 40a. Furthermore, the drawing content set by the drawing setting section 40a also includes a font. Furthermore, the drawing content set by the drawing setting section 40a includes a character type. Furthermore, the drawing content set by the drawing setting section 40a includes the number of characters. Moreover, the drawing content set by the drawing setting section 40a includes the density of drawing.

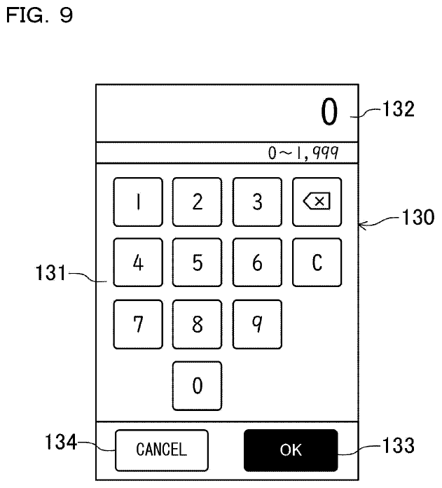

For example, when the user performs an operation of clicking the character height setting area 126c or the character interval setting area 126d, the display screen generation section 40e causes the controller-side display section 42a to display an input window 130 for the character height or the character interval as illustrated in FIG. 9. A numeric keypad 131 is provided in the input window 130. When the user operates the numeric keypad 131, the input numerical value is displayed on the numerical value display section 132. If there is no problem with the numerical value displayed on the numerical value display section 132, the OK button 133 is operated. As a result, the input numerical value is reflected in the character height setting area 126c or the character interval setting area 126d. To cancel the input of the numerical value, the cancel button 134 may be operated. Note that a numerical value may be input by operating a keyboard or the like without displaying the numeric keypad 131.

As described above, the block can be edited, that is, the drawing content can be set. Thereafter, the process proceeds to step SA4 of the flowchart of FIG. 3. In step SA4, the determination section 40d confirms whether the inspection by the inspection machine 3 is in the stable range on the basis of the drawing content set in step SA3 and the information regarding the inspection performance of the inspection machine 3. In step SA5, the determination section 40d determines whether or not it is within an inspection stable range on the basis of the confirmation result of step SA4, and in a case where it is determined that it is within the inspection stable range, the process proceeds to step SA6 and the block editing by the user is continued.

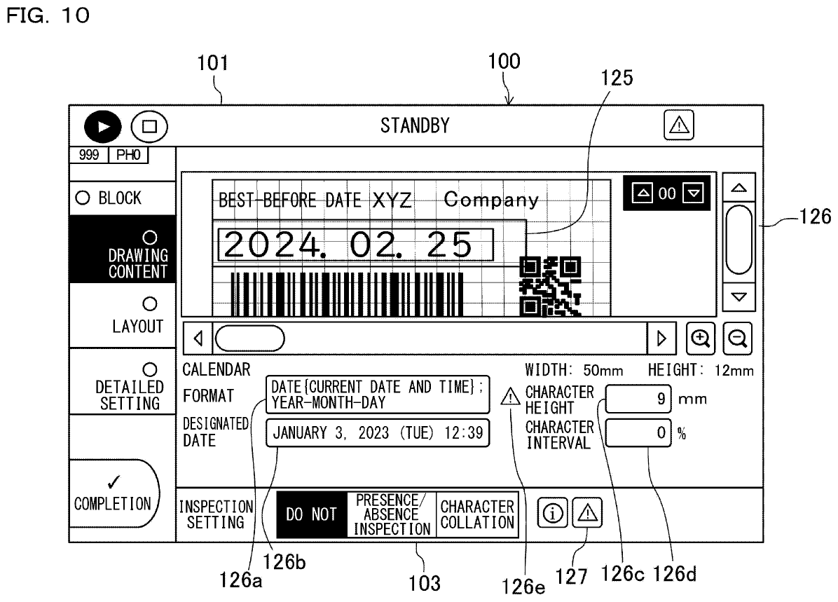

On the other hand, in a case where it is determined in step SA5 that the inspection by the inspection machine 3 is unstable, the processing proceeds to step SA7, and the user is notified that the inspection may not be stable. Specifically, as illustrated in FIG. 10, when the character height set in the character height setting area 126c is compared with the character height stored as the information regarding the inspection performance of the inspection machine 3, in a case where the character height set in the character height setting area 126c is lower and it is difficult for the inspection machine 3 to read the characters, the inspection by the inspection machine 3 becomes unstable, and thus, a warning mark 126e is displayed in the character height setting area 126c to notify the user. The form of the notification to the user is not limited to the display of the warning mark 126e, and may be, for example, a form in which the character height setting area 126c is displayed in a color different from the color at the time of setting, or a form in which a warning message is displayed. In a case where the character height at which the inspection is not stable is input, before and after the notification, prohibition processing of not reflecting the input character height in the setting area 126c or correction processing of automatically correcting the character height to the limit character height at which the inspection is stable may be performed.

Furthermore, when the process proceeds to step SA7, a warning mark 127 may be displayed at the lower part of the block editing screen 126. Warning marks 125e and 127 are a type of icons for displaying that the inspection is unstable as a result of the determination by the determination section 40d. The illustrated warning marks 125e and 127 are examples, and any form may be used as long as the user can recognize that the warning is issued. An area where the warning marks 125e and 127 are displayed is a display area of a determination result. That is, the display screen generation section 40e generates screen data in which the display area of the determination result is incorporated in the setting screen 100 for setting the drawing content, and outputs the screen data to the controller-side display section 42a. The controller-side display section 42a presents the determination result to the user by displaying the setting screen 100 in which the display area of the determination result is incorporated.

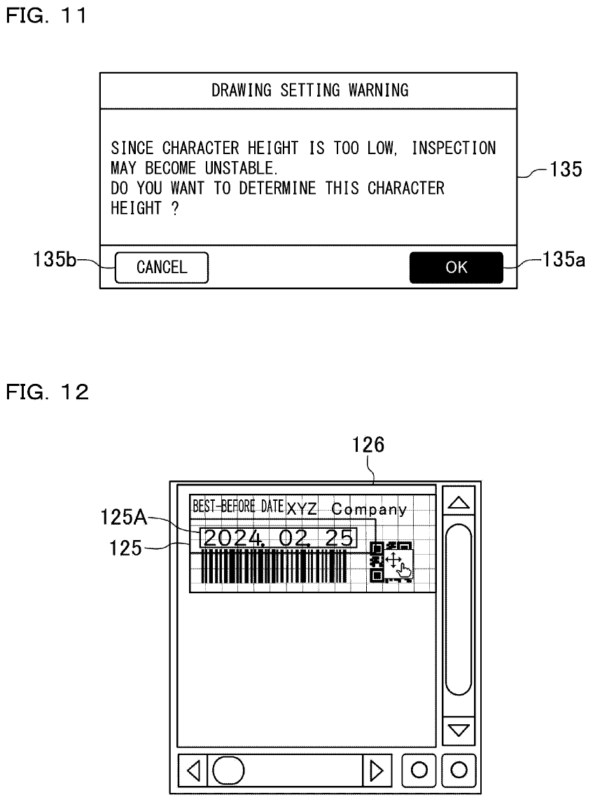

When the user performs an operation of pressing the warning mark 127, the display screen generation section 40e generates a message window 135 for displaying the determination reason illustrated in FIG. 11 and causes the controller-side display section 42a to display the message window. In the message window 135, the determination reason regarding the character size is described as the reason why the inspection by the inspection machine 3 is not stable. That is, in a case where the determination section 40d determines that the inspection by the inspection machine 3 is not stable, the display screen generation section 40e displays the warning mark 127 indicating that the inspection is not stable in the display area of the determination result, and does not display the message window 135 until the user performs an operation of pressing the warning mark 127, so that the message window 135 does not become an obstacle during the setting. On the other hand, in a case where the user desires to know the reason why the inspection is not stable, when the user performs an operation of pressing the warning mark 127, the display screen generation section 40e can detect the operation, generate a message window 135 as a reason display screen for displaying the determination reason by the determination section 40d, output the message window to the controller-side display section 42a, and display the message window on the controller-side display section 42a. In short, the display screen generation section 40e displays the message window 135 only when the user needs it. Note that the display screen generation section 40e may automatically display the message window 135 on the controller-side display section 42a at a stage where the warning mark 127 is not operated. Furthermore, the description content of the message window 135 may be any content as long as it explains the reason why the inspection is not stable, and is not limited to the illustrated content.

In step SA8, it is determined whether or not the user allows the inspection to be unstable. This determination can be made on the basis of an input by the user. For example, in a case where an OK button 135a of the message window 135 is operated, the user allows that the inspection is not stable. In this case, the processing proceeds to step SA6 to continue editing. On the other hand, in a case where a cancel button 135b of the message window 135 is operated, it means that the user does not allow the inspection to be unstable, and the process proceeds to step SA3, where the user resets the character height. The determination is made again in step SA5 based on the reset character height.

The drawing setting section 40a can also regulate the settable range of the drawing content on the basis of the determination result of the determination section 40d. For example, when the character height is set in the character height setting area 126c, the determination section 40d determines whether or not the inspection is stable with the set character height, and regulates the character height in which the inspection is not stable so that the character height cannot be set. As a result, only the character height at which the inspection is stable is allowed to be set.

Since the drawing content includes the font, the drawing setting section 40a can limit the settable font as the settable range of the drawing content. That is, the drawing setting section 40a limits the settable font to one preset font on the basis of the determination result of the determination section 40d. As a result, the drawing setting section 40a can disable selection of a specific font among a plurality of types of fonts. The drawing setting section 40a disables selection of a font other than the equal width font, for example.

Since the drawing content includes the character type, the drawing setting section 40a can limit the settable character type as the settable range of the drawing content. For example, a lowercase that is difficult to distinguish from an uppercase cannot be set, and a lowercase that is easy to distinguish from an uppercase can be set as a character type that can be set.

Since the drawing content includes the character interval, the drawing setting section 40a can limit a lower limit of the character interval that can be set as the settable range of the drawing content. For example, when the character interval is set in the character interval setting area 126d, the determination section 40d determines whether or not the inspection is stable at the set character interval, and the character interval at which the inspection is not stable is regulated so as not to be set. As a result, only the character interval at which the inspection is stable is allowed to be set.

As illustrated in an enlarged view of the block editing screen 126 in FIG. 12, the drawing setting section 40a can add a plurality of drawing elements (blocks) such as a character string, a barcode, and a two-dimensional code, and can change the interval between the plurality of added drawing elements. When the interval between the drawing elements is changed, an operation of selecting one drawing element is performed and a movement operation is performed, so that the drawing element can be separated from another drawing element or brought close to another drawing element. The movement operation is, for example, a drag operation or an operation of a movement button, and may be any operation.

The determination section 40d acquires information regarding the interval between the plurality of drawing elements. For example, the intervals between the plurality of drawing elements can be estimated by acquiring the sizes and position coordinates of the plurality of drawing elements. The determination section 40d determines whether or not the inspection by the inspection machine 3 is stable based on the information regarding the inspection performance of the inspection machine 3 and the interval between the plurality of drawing elements. For example, in a case where drawing elements are too close to each other, cutout of one drawing element becomes unstable, leading to deterioration of inspection performance by the inspection machine 3, the determination section 40d determines that the inspection becomes unstable. On the other hand, in a case where the drawing elements are sufficiently separated from each other and cutout of one drawing element can be stably performed, the determination section 40d determines that the inspection is stable.

Since it is difficult for the user to understand whether or not the interval between the plurality of drawing elements is appropriate, the display screen generation section 40e generates screen data as illustrated in FIG. 12, outputs the screen data to the controller-side display section 42a, and displays the screen data on the controller-side display section 42a. The screen data illustrated in FIG. 12 indicates the interval of drawing elements necessary for stabilizing the inspection.

Specifically, the frame line 125 in FIG. 12 indicates an interval of drawing elements necessary for stabilizing the inspection. The frame line 125 is larger than an outline display line 125A indicating the outermost shell of the character string of the date. The reason why the frame line 125 is made larger than the outline display line 125A is that, when the user selects and moves a block, if an interval with another drawing element (other character strings, bar codes, two-dimensional codes, etc.) is set with reference to the outermost shell of the character string, the inspection may not be stable. Not only the interval between the character strings but also the interval between the character strings and the codes and the interval between the codes are the same.

That is, in a case where the interval between the character string of the date and the other drawing elements is set with reference to the outline display line 125A of the character string of the date illustrated in FIG. 12, the interval between the character string of the date and the other drawing elements is narrowed, and as a result, the cutout of the character from the captured image becomes unstable, and there is a possibility that the inspection performance of the inspection machine 3 is deteriorated. On the other hand, the size of the frame line 125 is set such that an interval between the character string to be moved and another drawing element can secure an interval with high inspection performance by the inspection machine 3. Therefore, when the user performs the setting operation, the drawing elements are arranged such that the frame line 125 does not overlap with other drawing elements, so that deterioration of the inspection performance by the inspection machine 3 can be avoided. Furthermore, at the time of setting by the user, since the interval between the drawing elements is secured to be equal to or more than a predetermined value, the pre-processing of the inspection by the inspection machine 3 can be omitted, and the processing can be simplified.

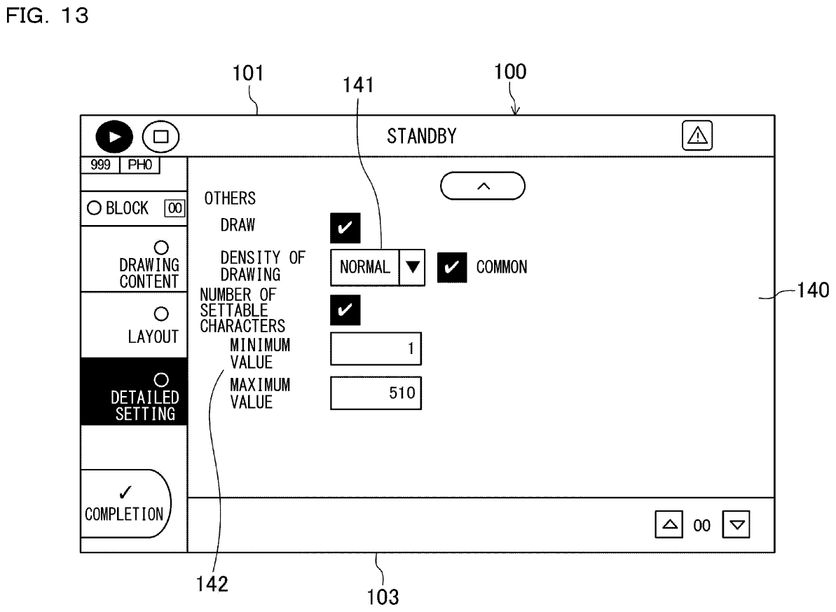

FIG. 13 illustrates a drawing density editing screen 140. The drawing density editing screen 140 is provided with a density setting area 141 for setting the density of drawing. In the density setting area 141, the density of drawing can be set in a plurality of stages. The drawing setting section 40a limits a lower limit of the settable density of drawing as the settable range of the drawing content. The lower limit of the density is set so that the inspection machine 3 can easily determine the drawing state.

Furthermore, the drawing density editing screen 140 is also provided with an area 142 for setting the minimum value and the maximum value of the number of settable characters. In a case where the number of characters can be set, the drawing setting section 40a can limit an upper limit of the number of characters that can be set as the settable range of the drawing content. The upper limit of the number of characters is set so that the inspection machine 3 can easily determine the drawing state.

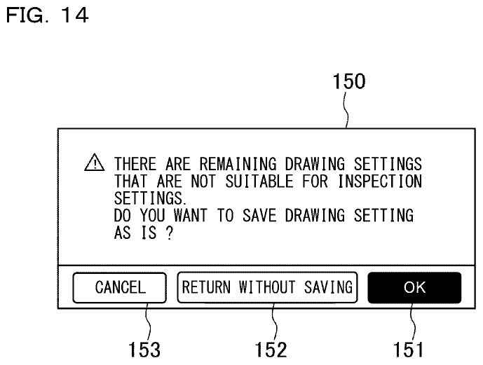

When the drawing setting is completed, the setting contents are stored in, for example, the storage section 41. In a case where the user performs the operation of saving the setting, there is a case where there remains a setting in which the inspection by the inspection machine 3 becomes unstable. In this case, the display screen generation section 40e generates a message window 150 for confirmation at the time of saving as illustrated in FIG. 14, outputs the message window to the controller-side display section 42a, and causes the controller-side display section 42a to display the message window. In the message window 150 for confirmation at the time of saving, a message indicating that there remains a setting that makes the inspection by the inspection machine 3 unstable is displayed as a text. In a case where the user operates an OK button 151 provided in the message window 150, the setting contents are saved as they are. On the other hand, in a case where the user operates a return button 152 provided in the message window 150, for example, the display screen generation section 40e generates the block editing screen 126 as illustrated in FIG. 8 and displays the block editing screen on the controller-side display section 42a. Furthermore, in a case where the user operates a cancel button 153 provided in the message window 150, the save operation is canceled. By displaying the save-time confirmation message window 150 before saving, it is possible to prevent the user from ending the setting without knowing that there remains a setting that makes the inspection unstable.

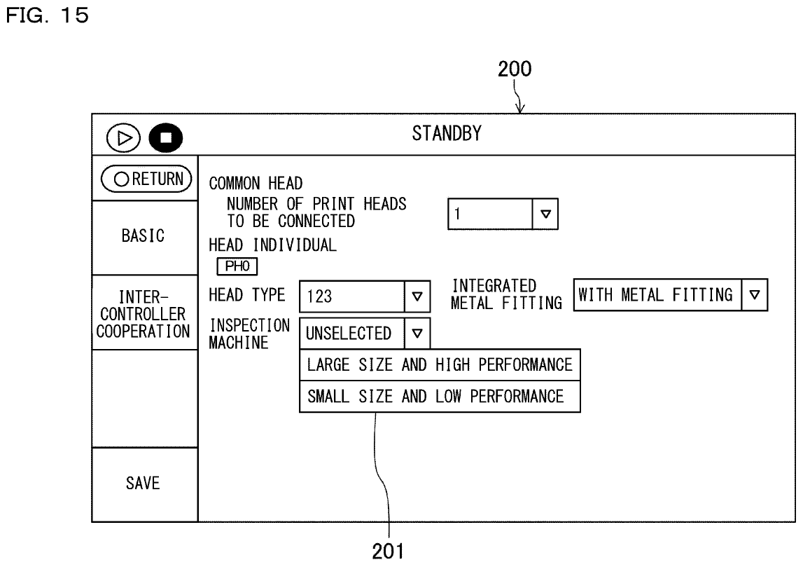

A system configuration screen 200 illustrated in FIG. 15 is, for example, a screen generated by the display screen generation section 40e and displayed on the controller-side display section 42a or the like. On the system configuration screen 200, the user can select the type of the inspection machine 3 connected to the controller 4. The storage section 41 stores information regarding predetermined inspection performance in association with the type of the inspection machine 3, and can vary the determination result of the inspection stable range by the determination section 40d according to the selected type of the inspection machine 3. With such a configuration, the user can easily perform drawing setting suitable for each inspection machine 3 even in a case where the user wants to use the inspection machines 3 depending on the application. Specifically, the system configuration screen 200 is provided with an option display area 201 that displays options of information regarding inspection performance and receives user's selection. The display name of the option in the option display area 201 may be a model name of the inspection machine 3 or a name indicating inspection performance of the inspection machine 3. Furthermore, the type of the inspection machine 3 is not limited, and the inspection mode of the inspection machine 3 may be stored in association with the information regarding the inspection performance.

### (Drawing Data Generation Device)

The ink jet printing apparatus 1 of the above embodiment includes the drawing machine 2, the inspection machine 3, and the controller 4, but the drawing machine 2 may be an ink jet printing apparatus. In this case, the controller 4 is a drawing data generation device that generates drawing data for the ink jet printing apparatus (drawing machine 2). The determination result of the determination section 40d of the controller 4 can be presented to the user by being displayed on the controller-side display section 42a, the terminal-side display section 5a, or the like. Therefore, the controller-side display section 42a and the terminal-side display section 5a are portions that can serve as a notification section that notifies the user of the determination result of the determination section 40d.

The above-described embodiments are merely examples in all respects, and should not be construed in a limiting manner. Moreover, all modifications and changes falling within the equivalent scope of the claims are within the scope of the present invention.

As described above, the present disclosure can be used, for example, in a case where various types of information are drawn on a packaging material such as cardboard.

What is claimed is:

1. An ink jet printing apparatus that ejects ink for drawing information on an object and determines quality of a drawing state by imaging, the ink jet printing apparatus comprising:
an ink accommodation section that accommodates the ink;
an ejection section that ejects the ink supplied from the ink accommodation section toward an object to be drawn;
a drawing setting section that sets a drawing content to be drawn on the object to be drawn;
a drawing data generation section that defines ejection of the ink in the ejection section and generates drawing data corresponding to the drawing content set by the drawing setting section;
an image inspection section that determines quality of a drawing state related to information drawn on the object to be drawn based on the drawing data by a captured image acquired by capturing an image of the object to be drawn;
a storage section that stores information regarding inspection performance of the image inspection section;
a determination section that determines whether or not an inspection by the image inspection section is stable based on the information regarding the inspection performance of the image inspection section stored in the storage section and the drawing content set by the drawing setting section; and
a notification section that notifies a user of a determination result of the determination section.

2. The ink jet printing apparatus according to claim 1, wherein the drawing setting section regulates a settable range of the drawing content based on the determination result of the determination section.

3. The ink jet printing apparatus according to claim 2, wherein
the drawing content set by the drawing setting section includes a font, and
the drawing setting section limits a settable font as the settable range of the drawing content.

4. The ink jet printing apparatus according to claim 3, wherein the drawing setting section limits the font to one preset font.

5. The ink jet printing apparatus according to claim 3, wherein the drawing setting section disables selection of a specific font from among a plurality of types of the fonts.

6. The ink jet printing apparatus according to claim 1, wherein
the image inspection section includes an imaging section that captures an image of the object to be drawn, and
the determination section determines whether or not the inspection by the image inspection section is stable based on the information regarding the inspection performance of the image inspection section and a distance between the imaging section and the object to be drawn.

7. The ink jet printing apparatus according to claim 1, wherein
the notification section is configured by a display section,
the ink jet printing apparatus further comprises a display screen generation section that generates screen data in which a display area of the determination result is incorporated in a drawing setting screen for setting the drawing content and outputs the screen data to the display section, and
the display section displays the drawing setting screen in which the display area of the determination result is incorporated.

8. The ink jet printing apparatus according to claim 7, wherein in a case where the determination section determines that the inspection by the image inspection section is not stable, the display screen generation section generates a reason display screen displaying a reason for determination by the determination section and outputs the reason display screen to the display section.

9. The ink jet printing apparatus according to claim 8, wherein in a case where the determination section determines that the inspection by the image inspection section is not stable, the display screen generation section causes an icon indicating that the inspection is not stable to be displayed in the display area of the determination result, and when a selection operation of the icon is performed, the display screen generation section generates the reason display screen and outputs the reason display screen to the display section.

10. The ink jet printing apparatus according to claim 8, wherein
the drawing content set by the drawing setting section includes a character size,
the drawing setting section receives setting of the character size by a user,
the determination section determines whether or not the inspection by the image inspection section is stable based on the information regarding the inspection performance of the image inspection section and the character size received by the drawing setting section, and
the display screen generation section generates a display screen displaying a determination reason regarding the character size and outputs the display screen to the display section in a case where the determination section determines that the inspection by the image inspection section is not stable due to the character size.

11. The ink jet printing apparatus according to claim 8, wherein
the drawing setting section is configured to be able to add a plurality of drawing elements and change an interval between the added plurality of drawing elements,
the determination section determines whether or not the inspection by the image inspection section is stable based on the information regarding the inspection performance of the image inspection section and the interval between the plurality of drawing elements, and
the display screen generation section generates screen data indicating the interval between the drawing elements necessary for stabilizing the inspection and outputs the screen data to the display section.

12. The ink jet printing apparatus according to claim 2, wherein
the drawing content set by the drawing setting section includes a character type, and
the drawing setting section limits a settable character type as the settable range of the drawing content.

13. The ink jet printing apparatus according to claim 2, wherein
the drawing content set by the drawing setting section includes a character interval, and
the drawing setting section limits a lower limit of the character interval that can be set as the settable range of the drawing content.

14. The ink jet printing apparatus according to claim 2, wherein
a drawing content set by the drawing setting section includes a number of characters, and
the drawing setting section limits an upper limit of the number of characters that can be set as the settable range of the drawing content.

15. The ink jet printing apparatus according to claim 2, wherein
the drawing content set by the drawing setting section includes a density of drawing, and
the drawing setting section limits a lower limit of the density of drawing that can be set as the settable range of the drawing content.

16. A drawing data generation device for an ink jet printing apparatus, the drawing data generation device comprising:
a drawing setting section that sets a drawing content;
a drawing data generation section that defines ejection of ink in an ejection section of the ink jet printing apparatus and generates drawing data corresponding to the drawing content set by the drawing setting section;
a storage section that stores information regarding inspection performance of an image inspection device that determines quality of a drawing state related to information drawn on an object to be drawn based on the drawing data by a captured image acquired by capturing an image of the object to be drawn;
a determination section that determines whether or not an inspection by the image inspection device is stable based on the information regarding the inspection performance of the image inspection device stored in the storage section and the drawing content set by the drawing setting section; and
a notification section that notifies a user of a determination result of the determination section.
